(19) United States
(12) Patent Application Publication
(10) Pub. No.: US 2007/0288837 A1
(43) Pub. Date: Dec. 13, 2007

(54) SYSTEM AND METHOD FOR PROVIDING CONTENT MANAGEMENT VIA WEB-BASED FORMS

(76) Inventors: John M. Eaves, Leander, TX (US); Robert E. Merx, Austin, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/423,712

(22) Filed: Jun. 13, 2006

(51) Int. Cl. G06F 17/00

(52) U.S. Cl. 715/505

(57) ABSTRACT

The present invention is a method for providing content management via web-based forms. The method includes loading an XML document. The method further includes creating a plurality of customizable web-based forms based upon the XML document. The plurality of customizable web-based forms may be configured for receiving a user input for allowing a user to perform at least one of: searching content of the XML document and editing content of the XML document. The plurality of customizable web-based forms may be further configured for presenting XML document content to the user in HTML format.

### FIELD OF THE INVENTION

The present invention relates to the field of dynamic e-business technology and particularly to a system and method for providing content management via web-based forms.

### BACKGROUND OF THE INVENTION

Web-based forms may currently be utilized for collecting data in systems such as a content management system. However, such web-based forms may be required to support a large number of business rules, thus making the web-based forms laborious to build and maintain. Further, in lieu of the above factors, if the number of web-based forms that must be built and maintained is large (ex: greater than 100), it may become cost prohibitive to build and maintain said forms using standard development methods (ex.—JAVA® Server Pages (JSP), JAVA® 2 Enterprise Edition (JAVA® 2 EE)). JAVA® is a registered trademark owned by SUN MICROSYSTEMS, INC., CORPORATION DELAWARE, 4150 Network Circle, Santa Clara, Calif. 95054. Current solutions (including vendor technology) have been implemented to address the aforementioned problems. However, said current solutions are lacking in that: 1) they may require development and deployment of code; (a process which may be time-consuming, expensive and may require a skilled developer) and/or 2) they may be too generic to support highly detailed and specific authoring capabilities.

Therefore, it may be desirable to have a system and method for providing content management via web-based forms which addresses the above-referenced problems and limitations of the current solutions.

### SUMMARY OF THE INVENTION

Accordingly, an embodiment of the present invention is directed to a method for providing content management via web-based forms. The method includes loading an XML document. The method further includes creating a plurality of customizable web-based forms based upon the XML document. The plurality of customizable web-based forms may be configured for receiving a user input for allowing a user to perform at least one of: searching content of the XML document and editing content of the XML document. The plurality of customizable web-based forms may be further configured for presenting XML document content to the user in HTML format.

In a further embodiment, the present invention is directed to a system for providing content management via web-based forms. The system includes: a template engine configured for creating a plurality of customizable web-based forms, the plurality of customizable web-based forms being based upon an XML document which has been loaded by the system, the plurality of customizable web-based forms further being configured for receiving a user input for allowing a user to perform at least one of: searching content of the XML document and editing content of the XML document, wherein the plurality of customizable web-based forms are configured for presenting XML document content to the user in HTML format.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram illustration of a system for providing content management in accordance with an exemplary embodiment of the present invention; and

FIG. 2 is a flow chart illustrating a method for providing content management via web-based forms in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

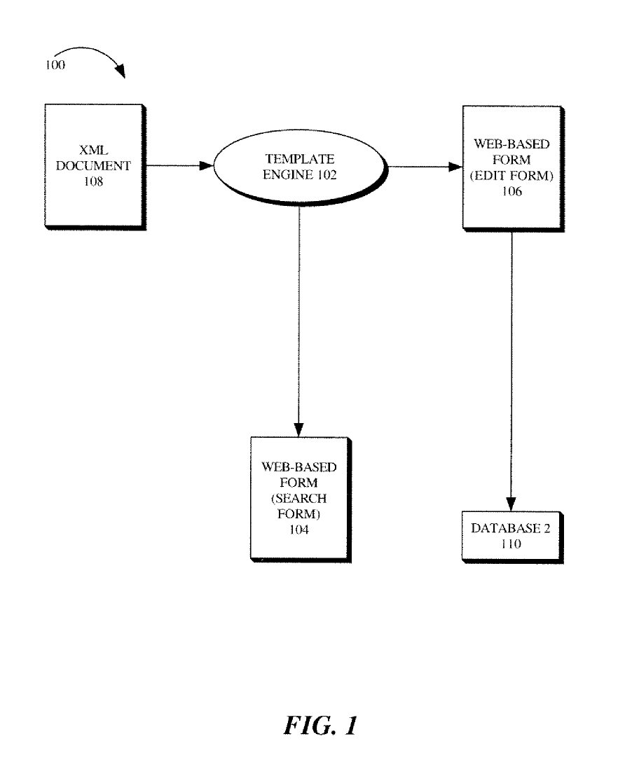

FIG. 1 illustrates a block diagram configuration for a system 100 for providing content management via web-based forms in accordance with an exemplary embodiment of the present invention. In a present embodiment, the system 100 includes a template engine 102 configured for creating a plurality of customizable web-based forms/entry templates (104, 106). In an exemplary embodiment, the plurality of customizable web-based forms (104, 106) may be based upon an XML (Extensible Markup Language) document 108 which has been loaded by the system 100. For instance, the XML document 108 may be a document which has been authored to include form layout rules and business rules. Form layout rules govern how content is presented via the plurality of web-based forms (104, 106). For instance, the form layout rules may dictate which fields should be presented via the web-based forms/entry templates (104, 106). Business rules serve as a mechanism for ensuring that information being presented via the web-based forms (104, 106) is in compliance with organizational rules and policies, said business rules being triggered upon the receipt of a “non-compliant” entry (i.e., a “bad data” entry). For instance, the business rules may include help text for guiding users as to proper usage of the customizable web-based forms (104, 106).

As discussed above, the XML document 108 may be loaded by the system 100. For example, the system 100 may upload the XML document 108, which may include transmitting the XML document from another system's database (not shown) to the illustrated system 100. In additional embodiments, the plurality of customizable web-based forms (104, 106) may further be configured for receiving a user input for allowing a user to perform at least one of: searching content of the XML document 108 and editing content of the XML document 108. For instance, a user may want to search for specific content of the XML document and edit said content in order to change the way that information is presented via electronic pages of the system 100. However, the user may not wish or may not be sophisticated enough to interact directly with the XML document 108. In the present embodiment, the plurality of customizable web-based forms (104, 106) may be configured for presenting XML document content to a user in HTML (Hyper Text Markup Language) format. For example, the content may be presented to a user in JAVA® Bean HTML format. Presenting XML document content in HTML format via customizable web-based forms (104, 106) provides for a more user-friendly manner of content management by allowing a user to locate and edit XML document content via the HTML web-based forms without having to interact directly with the XML document 108.

In an exemplary embodiment, the template engine 102 is updated in response to the XML document 108 being loaded and the plurality of customizable web-based forms (104, 106) being created. For example, the template engine 102 will determine the form layout and business rules (i.e., content) of the loaded XML document 108 and will create a plurality of customizable web-based forms (104, 106), as discussed above, based upon the content of the loaded XML document 108. In a present embodiment, the plurality of customizable web-based forms (104, 106) may be customized to provide a user with various ways to efficiently search and edit content of the XML document 108. For example, upon receiving a user input via a search form 104 included in the plurality of web-based forms (104, 106) requesting a certain category of content, an editing form included in the plurality of web-based forms (104, 106) which contains XML document content corresponding to the requested category, may be presented to the user, but in the more user-friendly HTML format. Once edits are made via the HTML web-based form, the system may incorporate the edits into the XML document 108 by outputting XML in the form of an edit-incorporating version of the XML document. The version of the XML document incorporating said edits may then be directed to other areas of the system 100 or another system, such as into a second database 110, for use in downstream applications. Thus, the system 100 of the present invention allows for efficient, customizable searching and editing of XML document content.

In present embodiments, a search form (104) included in the plurality of web-based forms (104, 106) may be customized to allow for advanced searching, such as searching all content of the XML document, searching a select set of content types, or searching specific fields within a single content type. In a current embodiment, the plurality of customizable web-based forms (104, 106) allow for field level searching of content of the XML document 108 based on web-based form/entry template definition, which may be customized by the user to facilitate authoring/editing of content. The plurality of web-based forms (104, 106) may be customized to include various fields for allowing a user to search and/or edit content. In a present embodiment, the plurality of customizable web-based forms may implement text fields. Text fields are basic text controls that let the user enter a small amount of text and allow the user to indicate that text entry is complete (usually by selecting “Enter” or the like). In situations where more than one line of input is to be obtained from the user, a text area field, which may be stretched horizontally or vertically to allow for more input space, may be implemented instead.

In further embodiments, the plurality of customizable web-based forms (104, 106) may implement rich text fields to allow for web-based rich text editing of the XML document 108. Rich text editing allows a user to edit content in a manner similar to using a word processing program. For example, rich text editing may allow a user to: change the font, size and color of the content/text; use boldface, underlining, and italics; center or justify text; or create links, all using a graphical interface (ex.—web-based form/entry template field) that makes editing simple by allowing a user to select the text he wants to format and to click the operation he wants to perform. In additional embodiments, the plurality of customizable web-based forms (104, 106) may implement file control fields including control buttons for allowing a user to cancel or save changes to content. Further, the plurality of customizable web-based forms (104, 106) may implement relationship fields and/or list controls (exs.—drop down box, check box, radio button) which may be hardcoded (inserted directly into a program, as opposed to being in some profile) or may lookup external values in a database.

In exemplary embodiments, a search form (104) included in the plurality of customizable web-based forms (104, 106) may be customized to allow for Direct Right Nav searches of content of the XML document 108. Direct Right Nav searches allow a user to search content for specific text, such as by using check boxes (having for example, designations such as: title, syndication key, owner, or status) below a search box to limit the scope of the search.

In additional embodiments, the plurality of customizable web-based forms (104, 106) allow for full text searching across all content of the XML document 108. For example, a user may be able to search the content using word or Boolean searches and the template engine 102 would examine all of the words of the XML document 108 in an attempt to match search words supplied by the user.

In further embodiments, a search form 104 included in the plurality of customizable web-based forms (104, 106) may be enhanced to allow for “AND OR” combination searching, which allows a user to combine search techniques to provide a more focused search. For instance, a user may combine one or more search terms as keywords or subjects using the Boolean operators “AND” or “OR” in order to search two or more concepts simultaneously. In additional embodiments, a search form 104 included in the plurality of customizable web-based forms (104, 106) may be enhanced to allow for selection of multiple attributes at any one time.

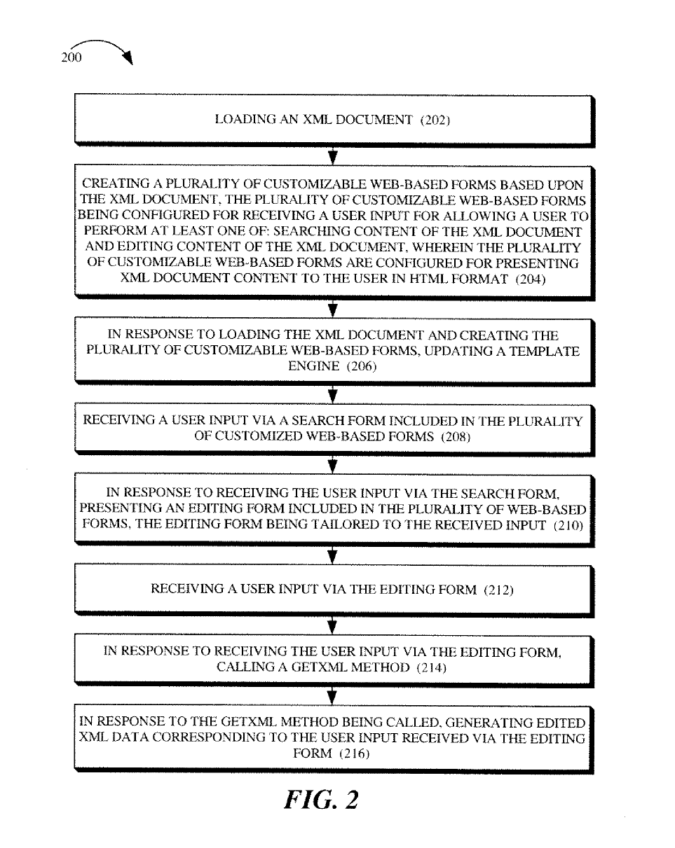

FIG. 2 is a flow chart illustrating a method for providing content management via web-based forms. The method 200 includes loading an XML document 202. The method 200 further includes creating a plurality of customizable web-based forms based upon the XML document 204. In an exemplary embodiment, the plurality of customizable web-based forms is configured for receiving a user input for allowing a user to perform at least one of: searching content of the XML document and editing content of the XML document. Further, the plurality of customizable web-based forms are configured for presenting XML document content to the user in HTML (Hyper Text Markup Language) format. The method 200 further includes, in response to loading the XML document and creating the plurality of customizable web-based forms, updating a template engine 206. The method 200 further includes receiving a user input via a search form included in the plurality of customizable web-based forms 208. The method 200 further includes, in response to receiving the user input via the search form, presenting an editing form included in the plurality of web-based forms, the editing form being tailored to the received input 210. For example, an input may be received by the search form requesting a particular category of content. The template engine may then retrieve an editing form including content corresponding to the requested category and present it to the user as an HTML formatted web-based form which allows for said content to be edited. The method 200 further includes receiving a user input via the editing form 212. The method 200 further includes, in response to receiving the user input via the editing form, calling a getXML method 214. The method 200 further includes, in response to the getXML method being called, generating edited XML in the form of a revised version of the XML document, the edited XML including editing directed by the user via the customizable web-based forms 216.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to connect to other data processing systems or storage devices through intervening private or public networks. Telephone modems, cable or DSL modems and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages are to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for providing content management via web-based forms, comprising:
loading an XML document; and
creating a plurality of customizable web-based forms based upon the XML document, the plurality of customizable web-based forms being configured for receiving a user input for allowing a user to perform at least one of: searching content of the XML document and editing content of the XML document,
wherein the plurality of customizable web-based forms are configured for presenting XML document content to the user in HTML format.

2. A method as claimed in claim 1, further comprising:
in response to loading the XML document and creating the plurality of customizable web-based forms, updating a template engine.

3. A method as claimed in claim 2, further comprising:
receiving a user input via a search form included in the plurality of customizable web-based forms.

4. A method as claimed in claim 3, further comprising:
in response to receiving the user input via the search form, presenting an editing form included in the plurality of web-based forms, the editing form being tailored to the received input.

5. A method as claimed in claim 4, further comprising:
receiving a user input via the editing form.

6. A method as claimed in claim 5, further comprising:
in response to receiving the user input via the editing form, calling a getXML method.

7. A method as claimed in claim 6, further comprising:
in response to the getXML method being called, generating edited XML data corresponding to the user input received via the editing form, the edited XML data incorporating editing directed by the user via the web-based forms.

8. A computer program product, comprising:
a computer useable medium including computer usable program code for performing a method for providing content management via web-based forms, the computer program product including:
computer usable program code for loading an XML document; and
computer usable program code for creating a plurality of customizable web-based forms based upon the XML document, the plurality of customizable web-based forms being configured for receiving a user input for allowing a user to perform at least one of: searching content of the XML document and editing content of the XML document,
wherein the plurality of customizable web-based forms are configured for presenting XML document content to the user in HTML format.

9. A computer program product as claimed in claim 8, further comprising:
computer usable program code for updating a template engine in response to loading the XML document and creating the plurality of customizable web-based forms.

10. A computer program product as claimed in claim 9, further comprising:
computer usable program code for receiving a user input via a search form included in the plurality of customizable web-based forms.

11. A computer program product as claimed in claim 10, further comprising:
computer usable program code for presenting an editing form included in the plurality web-based forms, the editing form being tailored to the received input in response to receiving the user input via the search form.

12. A computer program product as claimed in claim 11, further comprising:
computer usable program code for receiving a user input via the editing form.

13. A computer program product as claimed in claim 12, further comprising:
computer usable program code for calling a getXML method in response to receiving the user input via the editing form.

14. A computer program product as claimed in claim 13, further comprising:
computer usable program code for generating edited XML data corresponding to the user input received via the editing form, the edited XML data incorporating editing directed by the user via the web-based forms.

15. A system for providing content management via web-based forms, comprising:
a template engine configured for creating a plurality of customizable web-based forms, the plurality of customizable web-based forms being based upon an XML document which has been loaded by the system, the plurality of customizable web-based forms further being configured for receiving a user input for allowing a user to perform at least one of: searching content of the XML document and editing content of the XML document,
wherein the plurality of customizable web-based forms are configured for presenting XML document content to the user in HTML format.

16. A system as claimed in claim 15, wherein the template engine is updated in response to the XML document being loaded and the plurality of customizable web-based forms being created.

17. A system as claimed in claim 15, wherein the plurality of customizable web-based forms allow for field-level searching of content of the XML document.

18. A system as claimed in claim 15, wherein the plurality of customizable web-based forms allow for web-based rich text editing of the XML document.

19. A system as claimed in claim 15, wherein the plurality of customizable web-based forms allow for full text searching across all content of the XML document.

20. A system as claimed in claim 15, wherein the XML document includes business rules for editing.
